(19) United States
(12) Patent Application Publication
(10) Pub. No.: US 2013/0141340 A1
(43) Pub. Date: Jun. 6, 2013

(54) Multi-Surface Touch Sensor

(71) Applicant: Esat Yilmaz, Santa Cruz, CA (US)

(72) Inventor: Esat Yilmaz, Santa Cruz, CA (US)

(21) Appl. No.: 13/310,912

(22) Filed: Dec. 5, 2011

(51) Int. Cl. G06F 3/041

(52) U.S. Cl. 345/173

(57) ABSTRACT

In one embodiment, an apparatus includes a first substrate area with a first touch sensor disposed on it configured for a first surface of a device. The apparatus further includes a second substrate area with a second touch sensor disposed on it configured for a second surface of the device. An edge between the first and second surfaces of the device may comprise an angle of deviation between the first and second surfaces of at least approximately 45°. The apparatus may further include a flexible printed circuit (FPC) bonded to the first and second substrate areas, the FPC being configured to bend at the edge between the first and second surfaces.

### TECHNICAL FIELD

This disclosure generally relates to touch sensors.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive-display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

### BRIEF DESCRIPTION OF THE DRAWINGS

FIG. 1 illustrates an example touch sensor with an example touch-sensor controller.

FIG. 2 illustrates an example device with multiple touch-sensitive areas on multiple surfaces.

FIG. 3 illustrates example touch sensors with multiple substrates bonded to an example flexible printed circuit (FPC) with a touch-sensor controller.

FIG. 4 illustrates example touch sensors with a continuous substrate bonded to an example flexible printed circuit (FPC) with a touch-sensor controller.

FIG. 5 illustrates a cross section of an example device with multiple touch-sensitive areas on multiple surfaces.

FIG. 6 illustrates a cross section of another example device with multiple touch-sensitive areas on multiple surfaces.

### DESCRIPTION OF EXAMPLE EMBODIMENTS

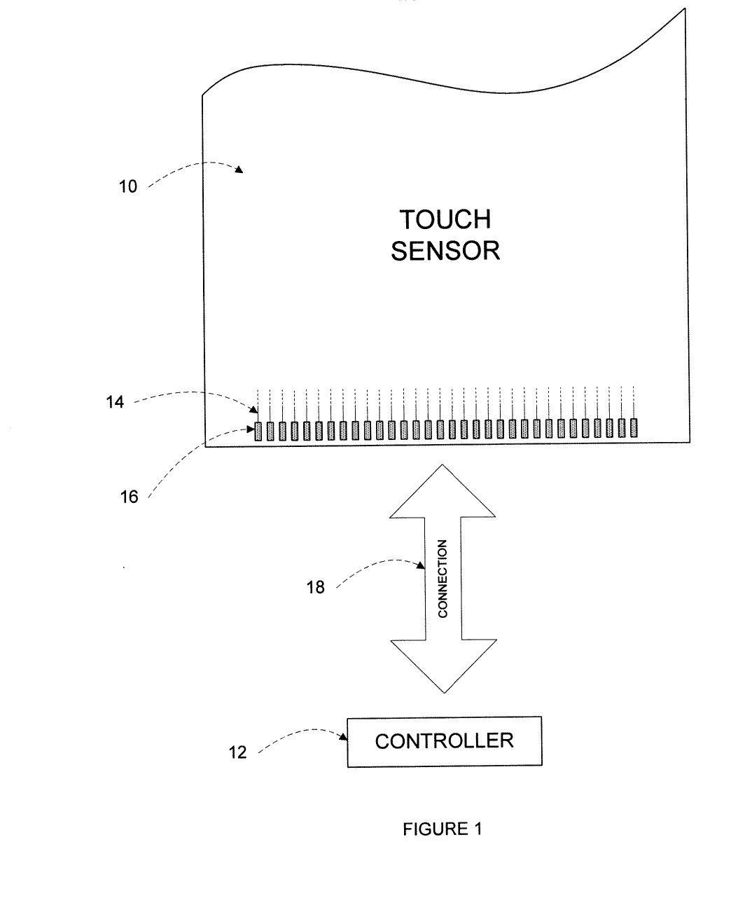

FIG. 1 illustrates an example touch sensor 10 with an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, thin line, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape (sometimes referred to as 100% fill), where appropriate. In particular embodiments, the conductive material of an electrode may occupy substantially less than 100% of the area of its shape. As an example and not by way of limitation, an electrode may be made of fine lines of metal or other conductive material (FLM), such as for example copper, silver, or a copper- or silver-based material, and the fine lines of conductive material may occupy approximately 5% of the area of its shape in a hatched, mesh, or other suitable pattern. Herein, reference to FLM encompasses such material, where appropriate. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fill percentages having any suitable patterns. Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs)) of a device that includes touch sensor 10 and touch-sensor controller 12, which may respond to the touch or proximity input by initiating a function of the device (or an application running on the device). Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive, where appropriate. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

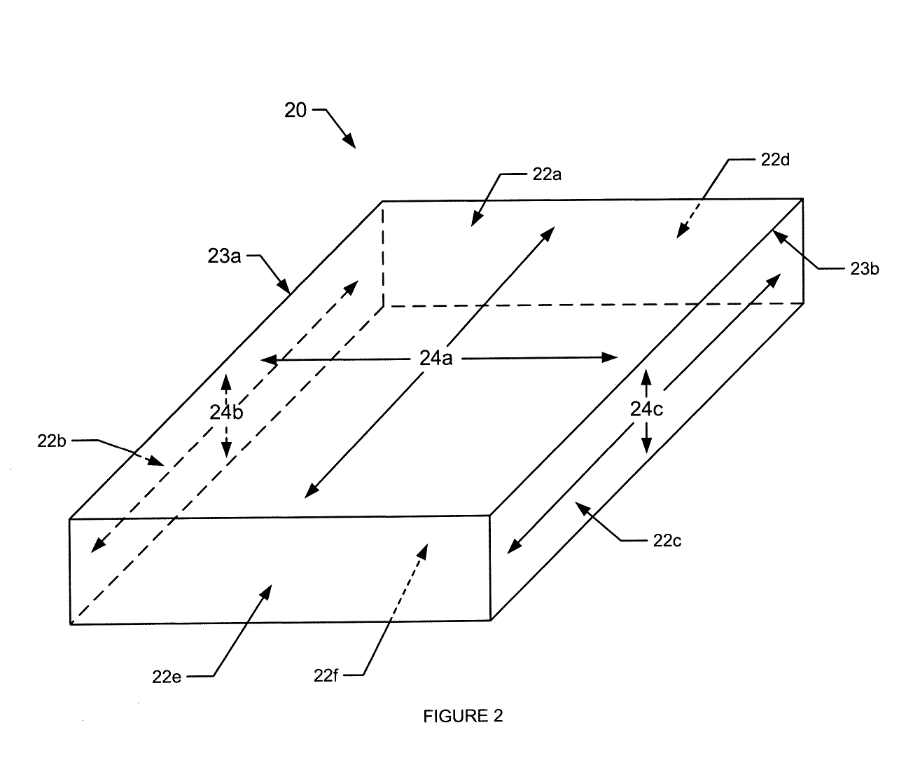

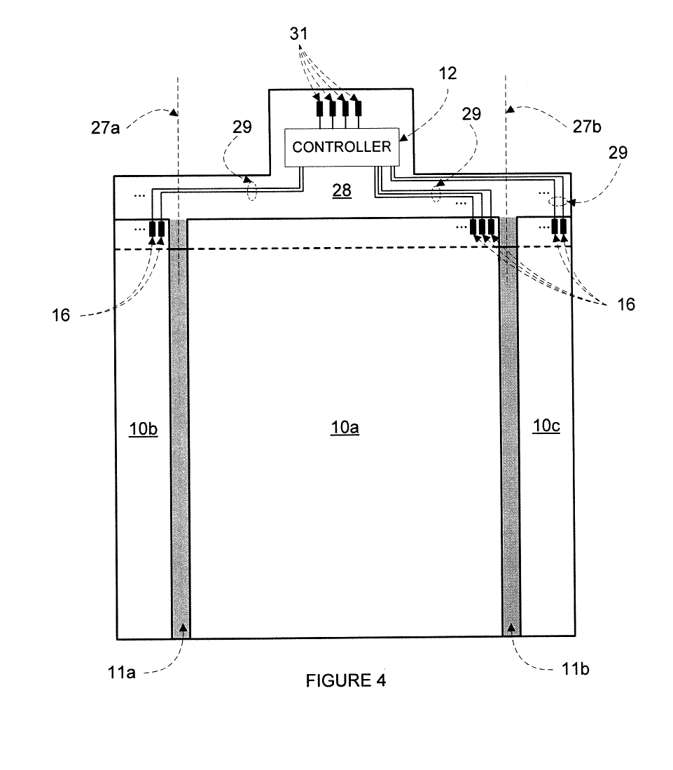

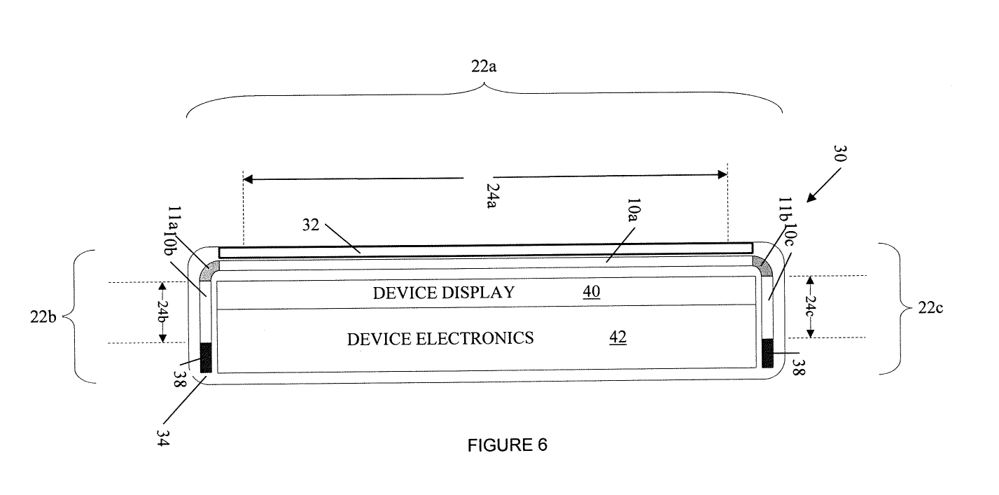

In particular embodiments, a device (e.g. device 20 of FIG. 2, device 30 of FIG. 4, or device 50 of FIG. 6) includes multiple touch sensors 10 on multiple surfaces of the device, with the multiple surfaces being separated by edges of the device. Such embodiments may provide one or more touch-sensitive areas on each of the multiple surfaces, thereby providing enhanced user interface functionality as compared to typical devices that include touch-sensitive areas on only a single surface of a device. Embodiments including touch sensors 10 on multiple surfaces of a device increase the amount of the total surface area of a device that is available for touch-sensitive applications relative to a device with a touch sensor 10 on a single surface. In particular embodiments, a device includes multiple touch sensors 10 that each include electrodes made of substantially rigid material. Such embodiments provide for multiple touch-sensitive areas on multiple surfaces of the device without requiring the use of electrodes made of a flexible material.

FIG. 2 illustrates an example device 20 with touch-sensitive areas 24 on multiple surfaces 22. As described above, examples of device 20 may include a smartphone, a PDA, a tablet computer, a laptop computer, a desktop computer, a kiosk computer, a satellite navigation device, a portable media player, a portable game console, a point-of-sale device, another suitable device, a suitable combination of two or more of these, or a suitable portion of one or more of these. Device 20 has multiple surfaces 22, such as front surface 22a, left-side surface 22b, right-side surface 22c, top surface 22d, bottom surface 22e, and back surface 22f. A surface 22 is joined to another surface at an edge 23 of the device. For example, adjoining surfaces 22a and 22b meet at edge 23a and adjoining surfaces 22a and 22c meet at edge 23b. Edges may have any suitable angle of deviation and any suitable radius of curvature. In particular embodiments, edges 23 have an angle of substantially 90 degrees and a radius of curvature from about 1 mm to about 9 mm. Although this disclosure describes and illustrates a particular device with a particular number of particular surfaces with particular shapes and sizes, this disclosure contemplates any suitable device with any suitable number of any suitable surfaces with any suitable shapes (including but not limited to being planar in whole or in part, curved in whole or in part, flexible in whole or in part, or a suitable combination of these) and any suitable sizes.

Device 20 has touch-sensitive areas 24 on more than one of its surfaces 22. In the example of FIG. 2, device 20 includes a touch-sensitive area 24a on front surface 22a, a touch-sensitive area 24b on left-side surface 22b, and a touch-sensitive area 24c on right-side surface 22c. Each of the touch-sensitive areas 24a, 24b, and 24c detect the presence and location of a touch or proximity input on their respective surfaces. One or more of touch-sensitive areas 24 may each extend to near one or more of the edges of its surface 22. In the example of FIG. 2, touch-sensitive area 24a on front surface 22a extends substantially out (but not all the way) to all four edges of front surface 22a, touch-sensitive area 24b on left-side surface 22b extends substantially out (but not all the way) to the lower and upper edges of left-side surface 22b, and touch-sensitive area 24c on right-side surface 22c extends substantially out (but not all the way) to the lower and upper edges of right-side surface 22c. Touch-sensitive area 24b may occupy any suitable portion of surface 22b between the top and bottom edges of surface 22b, subject to limitations posed by the edges of the surface and other surface features, such as mechanical buttons or electrical connector openings which may be on the surface, and touch-sensitive area 24c may occupy any suitable portion of surface 22c between the top and bottom edges of surface 22c and 24c.

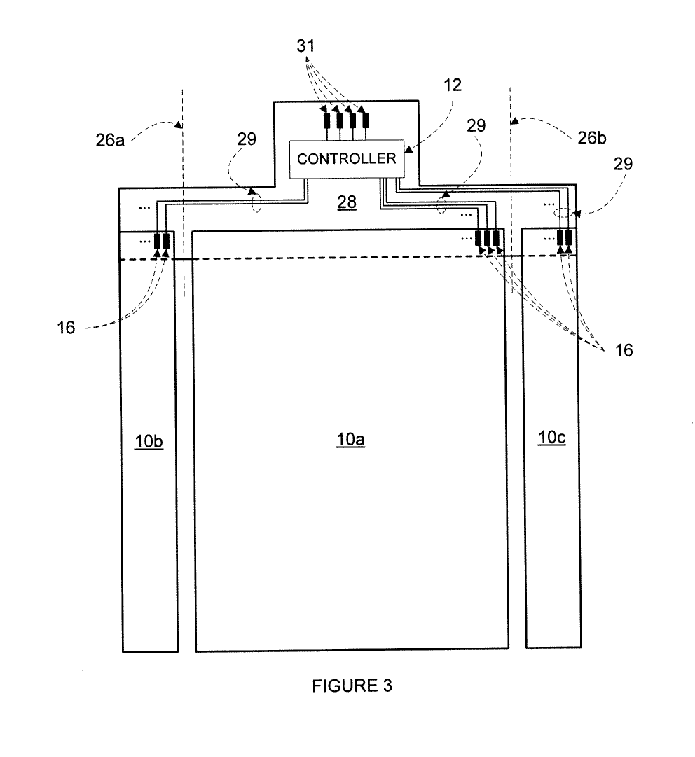

FIG. 3 illustrates touch sensors 10a-10c connected (e.g. bonded) to an FPC 28 with a single touch-sensor controller 12. In the example of FIG. 3, each touch sensor 10 may provide a distinct touch-sensitive area 24. For example, touch sensor 10a may provide touch-sensitive area 24a for front surface 22a of device 20, touch sensor 10b may provide touch-sensitive area 24b for left-side surface 22b of device 20, and touch-sensitive area 24c may provide touch sensitive area 24c for right-side surface 22c of device 20.

In the embodiment of FIG. 3, each touch sensor 10 is formed on a distinct substrate. The substrates housing the touch sensors 10 in FIG. 3 are physically isolated from each other, and thus are not contiguous with respect to each other. In particular embodiments, an air gap or dielectric material is positioned between adjacent substrates and their respective touch sensors 10. As depicted, touch sensors 10 may also be physically or electrically isolated from each other. For example, a touch sensor 10 may include one or more distinct sets of electrodes that are not continuous with respect to one or more distinct sets of electrodes of another touch sensor 10. Thus, touch-sensitive areas implemented by touch sensors 10 may be separated by areas that are not touch-sensitive.

Discrete substrates and their respective touch sensors 10 may be manufactured in any suitable manner. In particular embodiments, a continuous substrate with multiple touch sensors 10 formed thereon is cut along cut lines 26 to form multiple discrete substrates with respective touch sensors 10. In particular embodiments, a cut may pass through an entire cross section of a substrate from one edge to another, splitting the substrate into two distinct substrates. In another embodiment, a cut may pass only partially through any suitable cross section of the substrate from one edge but not all the way to the other, creating two portions of the substrate that remain coupled by an amount of substrate. The cut may pass through any suitable portion of the cross section of the substrate, such as 50%, 80%, 90%, or more. For example, a cut may extend from the bottom edge of the substrate to near the location on the substrate where the connection pads 16 are formed or from the bottom edge of the substrate to near the top edge. Such embodiments may aid in alignment of the touch sensors 10 during manufacturing. The cutting step may occur before or after bonding (or other method of connecting) to FPC 28 occurs. In other particular embodiments, the substrates and their respective touch sensors 10 may be manufactured separately and then bonded (or otherwise connected) to FPC 28.

In particular embodiments, each touch sensor 10 is formed on a distinct substrate set that includes a stack of multiple substrates. Each substrate set may be physically isolated from each other substrate set. That is, each substrate of a particular substrate set may be separated from each substrate of an adjacent substrate set by an air gap or dielectric material. The structure, functionality, or other characteristics described herein with respect to touch sensors 10 formed on distinct substrates may also apply to touch sensors 10 formed on distinct substrate sets.

FIG. 4 illustrates touch sensors 10a-10c formed on a continuous substrate and connected (e.g. bonded) to an FPC 28 with a single touch-sensor controller 12. The components of FIG. 4 may have similar characteristics to corresponding components described in connection with FIG. 3. However, in the embodiment of FIG. 4, the touch sensors 10 are formed on a continuous substrate instead of separate substrates. As depicted, touch sensors 10 may be physically or electrically isolated from each other despite being housed on the same substrate. For example, a touch sensor 10 may include one or more distinct sets of electrodes that are not continuous with respect to one or more distinct sets of electrodes of another touch sensor 10. In the embodiment depicted, portions 11a and 11b of the continuous substrate do not include drive or sense electrodes and the substrate is made of a substantially flexible material (such as PET). Accordingly, the substrate may be bent along fold lines 27a and 27b to provide touch sensors 10 for multiple surfaces of a device without risking damage to the electrodes of touch sensors 10. The folding may be performed at any suitable time during manufacturing, such as before or after the electrodes are formed on the substrate and before or after bonding with (or otherwise connecting to) the FPC 28. In particular embodiments, portions 11a and 11b includes electrode material that is not used for sensing purposes. For example, manufacturing may be facilitated by laying an electrode pattern across the entire substrate, but only using selected portions of the electrode pattern are used as touch sensors 10. In such embodiments, performance is not degraded if the non-touch-sensitive electrode material on portions 11a or 11b break during bending.

The folded substrate may wrap around an edge 23 from one surface 22 of a device 20 to another surface 22. As an example and not by way of limitation, the substrate may wrap around the edge between touch-sensitive area 24a on front surface 22a of device 20 and touch-sensitive area 24c on right-side surface 22c of device 20.

In particular embodiments, touch sensors 10 are formed on a continuous substrate set that includes a stack of multiple continuous substrates. The continuous substrate set may be bent along fold lines 27a and 27b to wrap around edges of a device in order to provide touch-sensitive areas on multiple surfaces of the device as described above with respect to touch sensors 10 formed on a continuous substrate. The structure, functionality, or other characteristics described herein with respect to touch sensors 10 formed on a continuous substrate may also apply to touch sensors 10 formed on a continuous substrate set.

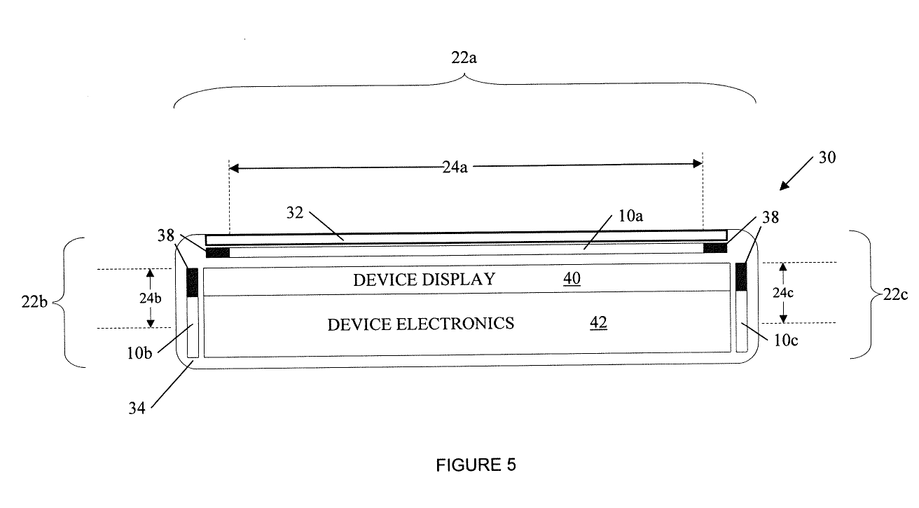

Multiple discrete touch sensors 10 on one or more substrates may provide touch-sensitive areas 24 for multiple surfaces 22 of a device (as depicted in FIGS. 5 and 6), even when touch sensors 10 include substantially rigid materials (such as ITO). Such embodiments avoid the bending of (and possible damage to) substantially rigid material that might occur if a single continuous touch sensor 10 is wrapped around a device edge. As used herein, a substantially rigid material is a material that suffers breakage or a decrease in functionality if the material is bent such that an angle of deviation between a first surface of the material and a second surface of the material is greater than or equal to approximately 45 degrees. Conversely, a substantially flexible material is a material that does not suffer breakage or a decrease in functionality if the material is bent such that an angle of deviation between a first surface of the material and a second surface of the material is greater than or equal to approximately 45 degrees.

Referring jointly to FIGS. 3 and 4, touch-sensor controller 12 may detect and process the presence and location of a touch or proximity input on a touch sensor 10 in a touch-sensitive area 24. In particular embodiments, a single touch-sensor controller 12 may detect and process touches and proximity inputs from multiple touch sensors 10 disposed on multiple surfaces of device 20. In other embodiments, more than one touch-sensor controller 12 may be used to detect and process touches and proximity inputs from multiple touch sensors 10 disposed on multiple surfaces of device 20.

One or more connection pads (not explicitly shown) on FPC 28 may couple touch-sensor controller 12 to corresponding connection pads 16 at the ends of tracks of conductive material extending into or around (e.g. at the edges of) touch-sensitive areas 24. The tracks may couple the drive and sense electrodes of the touch sensors 10 to connection pads 16, in turn connecting them to touch-sensor controller 12 via conductive lines 29.

In particular embodiments, FPC 28, conductive lines 29, and tracks 14 disposed on the substrate to electrically connect the touch sensor electrodes to the connection pads 16 may each be made of substantially flexible material (such as fine lines of metal or other conductive material), enabling them to wrap around an edge from one surface 22 of a device 20 to another surface 22. As an example and not by way of limitation, the substrate may wrap around the edge between touch-sensitive area 24a on front surface 22a of device 20 and touch-sensitive area 24c on right-side surface 22c of device 20. In particular embodiments, FPC 28 and conductive lines 29 may be folded at fold lines 27 without affecting the operation of conductive lines 29 or touch-sensor controller 12. Wrapping FPC 28 and conductive lines 29 around one or more edges of device 20 may facilitate the use of a single touch-sensor controller 12 with multiple touch sensors 10 on multiple surfaces of device 20.

In particular embodiments, the narrowness of the lines forming the drive and sense electrodes may leave space in touch-sensitive areas 24 for the tracks to extend into or along the edges of touch-sensitive areas 24 without substantially disrupting the patterns of drive electrodes and sense electrodes anywhere in touch-sensitive areas 24. As a result, the tracks may extend into or along the edges of touch-sensitive areas 24 without creating substantial dead zones in or along touch-sensitive areas 24. A dead zone may be an area where there is no deliberate sensing to detect the presence or location of a touch or proximity input. In addition or as an alternative, the narrowness of the lines forming the tracks may enable them to extend into or along the edges of touch-sensitive areas 24 without substantially disrupting the patterns of drive electrodes and sense electrodes anywhere in touch-sensitive areas 24. In particular embodiments, tracks may run at or near the edges of device 20 in between touch-sensitive areas 24 provided by touch sensors 10. By way of example, tracks may be coupled to FPC 28 and run in a non-touch-sensitive area (such as 11a) between touch sensors 10a and 10b.

In particular embodiments, the substrate(s) may be bonded (or otherwise connected) to a single FPC and driven from one touch-sensor controller. The touch sensors 10 may be placed on surfaces 22 of a device 20 that are substantially perpendicular to each other or, if there is no substantial distinction between the surfaces of the device (such as, for example, a pebble-shaped or curved device), an angle of deviation between the surfaces of 45° or greater.

FIG. 5 illustrates a cross section of an example device 30 with multiple touch-sensitive areas 24 on multiple surfaces 22. Device 30 includes a cover panel 32, device housing 34, touch sensors 10 (with tracking areas 38 containing the tracks 14), device display 40, and device electronics 42. Device 30 has touch-sensitive areas 24 on its left-side surface 22b, its front surface 22a, and its right-side surface 22c. Touch-sensitive area 24a on front surface 22a of device 30 extends toward (but not necessarily all the way to) the left and right edges of front surface 22a of device 30, and touch-sensitive areas 24b and 24c on left-side and right-side surfaces 22b and 22c extend from proximate the front edges of left-side and right-side surfaces 22b and 22c toward (but not necessarily all the way to) the back edges of left-side and right-side surfaces 22b and 22c.

Touch sensors 10 each include a substrate with electrodes disposed on it. In the example of FIG. 5, three substrates that each include a set of electrodes provides three touch sensors 10a-10c for touch-sensitive areas 24 on front surface 22a, left-side surface 22b, and right-side surface 22c of device 30. These three substrates may correspond to the three substrates shown in FIG. 3. In particular embodiments, a substrate of a touch sensor 10 may include or have attached to it a tracking area 38, which may include tracks providing drive and sense connections to and from the drive and sense electrodes of touch sensors 10 in touch-sensitive areas 24 of device 30.

Device display 40 may be a liquid crystal display (LCD), a light-emitting diode (LED) display, an LED-backlight LCD, or other suitable display and may be visible through cover panel 32 and touch sensor 10a (and the drive and sense electrodes disposed on it). Although this disclosure describes and illustrates a particular device display and particular display types, this disclosure contemplates any suitable device display and any suitable display types. Device electronics 42 may provide the functionality of device 30. As example and not by way of limitation, device electronics 42 may include circuitry or other electronics for wireless communication to or from device 30, running applications on device 30, generating graphical or other user interfaces (Uls) for device display 40 to display to a user, managing power to device 30 from a battery or other power source, taking still pictures, recording video, other suitable functionality, or a suitable combination of these. In particular embodiments, device electronics 42 may communicate with touch-sensor controller 12 (e.g. through connection pads 31 depicted in FIGS. 3 and 4). Although this disclosure describes and illustrates particular device electronics providing particular functionality of a particular device, this disclosure contemplates any suitable device electronics providing any suitable functionality of any suitable device.

FIG. 6 illustrates a cross section of an example device 50 with multiple touch-sensitive areas 24 on multiple surfaces 22. The components of FIG. 6 may have similar characteristics to corresponding components described in connection with FIG. 5. However, in the embodiment of FIG. 6, the touch sensors 10 are formed on a continuous substrate instead of three separate substrates. The continuous substrate wraps around the left and right edges of front surface 22a to left-side and right-side surfaces 22b and 22c. The continuous substrate may correspond to the continuous substrate depicted in FIG. 4.

In particular embodiments, such as the example of FIG. 2, one or more touch-sensitive areas 24 cover less than the entire area of their respective surfaces 22. In particular embodiments, one or more touch sensitive areas 24 may cover only a small portion of their respective surfaces 22. In particular embodiments, one or more touch-sensitive areas 24 on one or more surfaces 22 may implement one or more discrete touch-sensitive buttons, sliders, or wheels. In particular embodiments, a single touch sensor 10 may include multiple touch objects, such as X-Y matrix areas, buttons, sliders, wheels, or combinations thereof. For example, a touch sensor 10 may include an X-Y matrix area, with three buttons below the matrix area, and a slider below the buttons. Although this disclosure describes and illustrates a particular number of touch-sensitive areas with particular shapes and sizes on a particular number of particular surfaces of a particular device, this disclosure contemplates any suitable number of touch-sensitive areas of any suitable shapes, sizes, and input types (e.g. X-Y matrix, button, slider, or wheel) on any suitable number of any suitable surfaces of any suitable device.

In particular embodiments with a continuous substrate, thick or wide extension tracking may be disposed on the substrate at the edges of device 30 and join touch sensors 10 on either side of the bend of the substrate (at the edge of device 30 disposed between two adjacent touch sensors 10) to facilitate wrapping around sharper edges of the device. A two-layer configuration may be used on the flat portions of the device. Although this disclosure describes particular techniques for wrapping around sharper edges of a device, this disclosure contemplates any suitable technique for wrapping around sharper edges of a device.

Particular embodiments of the present disclosure may provide one or more or none of the following technical advantages. In particular embodiments, a multi-surface touch sensor system may be provided. Such embodiments may provide multiple touch-sensitive areas on multiple surfaces. Particular embodiments may include keys or buttons implemented by touch sensors on one or more surfaces of a device that may be used in place of mechanical keys or buttons of the device. Particular embodiments may increase the amount of area of a device that is available for touch-sensitive applications. Particular embodiments may provide a device comprising touch sensors with electrodes made of substantially rigid material that provide multiple touch-sensitive areas on multiple surfaces of a device.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An apparatus comprising:
a first substrate area with a first touch sensor disposed on it configured for a first surface of a device;
a second substrate area with a second touch sensor disposed on it configured for a second surface of the device, there being an edge between the first and second surfaces of the device comprising an angle of deviation between the first and second surfaces of at least approximately 45°; and
a flexible printed circuit (FPC) bonded to the first and second substrate areas, the FPC being configured to bend at the edge between the first and second surfaces.

2. The apparatus of claim 1, wherein:
the first substrate area and the second substrate area are distinct portions of the same substrate, wherein the substrate is substantially flexible and configured to bend at the edge between the first and second surfaces; and
the first touch sensor is not contiguous with the second touch sensor.

3. The apparatus of claim 1, wherein the first substrate area is provided by a first substrate that is physically distinct from a second substrate that provides the second substrate area.

4. The apparatus of claim 1, wherein the edge between the first and second surfaces has an angle of deviation of approximately 90°.

5. The apparatus of claim 1, wherein the edge between the first and second surfaces of the device has a radius of curvature of between approximately 1 millimeter and 9 millimeters.

6. The apparatus of claim 1, wherein the first and second touch sensors comprise electrodes made of conductive material that is substantially rigid.

7. The apparatus of claim 1, wherein the first and second touch sensors comprise electrodes made of indium tin oxide (ITO).

8. The apparatus of claim 1, wherein:
the apparatus further comprises a third substrate area with a third touch sensor disposed on it configured for a third surface of the device, there being another edge between the first and third surfaces of the device comprising an angle of deviation of at least approximately 45°; and
the FPC is also bonded to the third substrate area.

9. The apparatus of claim 1, wherein:
the first touch sensor has a touch-sensitive area that extends substantially out to at least two edges of the first surface; or
the second touch sensor has a touch-sensitive area that extends substantially out to at least two edges of the second surface.

10. The apparatus of claim 1, wherein the first surface is a front of the device and the second surface is a right or left side of the device.

11. An apparatus comprising:
a first substrate area with a first touch sensor disposed on it configured for a first surface of a device;
a second substrate area with a second touch sensor disposed on it configured for a second surface of the device, there being an edge between the first and second surfaces of the device comprising an angle of deviation between the first and second surfaces of at least approximately 45°; and
a flexible printed circuit (FPC) bonded to the first and second substrate areas, the FPC being configured to bend at the edge between the first and second surfaces, the FPC coupling the first and second touch sensor to a touch-sensor controller.

12. The apparatus of claim 11, wherein:
the first substrate area and the second substrate area are distinct portions of the same substrate, wherein the substrate is substantially flexible and configured to bend at the edge between the first and second surfaces; and
the first touch sensor is not contiguous with the second touch sensor.

13. The apparatus of claim 11, wherein the first substrate area is provided by a first substrate that is physically distinct from a second substrate that provides the second substrate area.

14. The apparatus of claim 11, wherein the edge between the first and second surfaces has an angle of deviation of approximately 90°.

15. The apparatus of claim 11, wherein the edge between the first and second surfaces of the device has a radius of curvature of between approximately 1 millimeter and 9 millimeters.

16. The apparatus of claim 11, wherein the first and second touch sensors comprise electrodes made of conductive material that is substantially rigid.

17. The apparatus of claim 11, wherein the first and second touch sensors comprise electrodes made of indium tin oxide (ITO).

18. The apparatus of claim 11, wherein:
the apparatus further comprises a third substrate area with a third touch sensor disposed on it configured for a third surface of the device, there being another edge between the first and third surfaces of the device comprising an angle of deviation of at least approximately 45°; and
the FPC is also bonded to the third substrate area.

19. The apparatus of claim 11, wherein:
the first touch sensor has a touch-sensitive area that extends substantially out to at least two edges of the first surface; or
the second touch sensor has a touch-sensitive area that extends substantially out to at least two edges of the second surface.

20. The apparatus of claim 11, wherein the first surface is a front of the device and the second surface is a right or left side of the device.

21. A device comprising:
a first substrate area with a first touch sensor disposed on it configured for a first surface of the device;
a second substrate area with a second touch sensor disposed on it configured for a second surface of the device, there being an edge between the first and second surfaces of the device comprising an angle of deviation between the first and second surfaces of at least approximately 45°;
a flexible printed circuit (FPC) bonded to the first and second substrate areas, the FPC bending across the edge between the first and second surfaces, the FPC coupling the first and second touch sensor to a touch-sensor controller; and
a display overlaid by at least a portion of the first touch sensor.
